(19) United States
(12) Patent Application Publication
(10) Pub. No.: US 2004/0127184 A1
(43) Pub. Date: Jul. 1, 2004

(54) METHOD FOR RECEIVING RADIO SIGNALS WITH AN ACCESS POINT

(76) Inventor: Meng-Hua Kao, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,186

(22) Filed: Dec. 25, 2002

(51) Int. Cl. H04B 1/06; H04B 7/00

(52) U.S. Cl. 455/272

(57) ABSTRACT

A method for receiving radio frequency signals transmitted by a radio signal transmitter with an access point includes using a plurality of antennas to receive radio signals transmitted by the radio signal transmitter and from other directions via reflection during a predetermined period of time, and using the processor to sum up radio signals received by the plurality of antennas during the predetermined period of time to obtain a summation of radio signals transmitted directly from the radio signal transmitter to the access point and of radio signals transmitted via reflection from the radio signal transmitter to the access point.

### BACKGROUND OF THE INVENTION

1. Field of the Invention

The present invention relates to a method for receiving radio signals with an access point, and more specifically, to a method for receiving a summation of radio signals transmitted directly from a radio signal transmitter to the access point and of radio signals transmitted via reflection from the radio signal transmitter to the access point.

2. Description of the Prior Art

Recently, the spread spectrum technique has become one of the ideal wireless communication means due to its characteristics of co-channel interference and low probability of interception. The spread spectrum technique applies to various kinds of electronic communication, such as WLAN (PC to PC), bar code scanners, mobile phones, and the latest personal communication network/personal communication service (PCN/PCS) technology.

The difference between the spread spectrum technique and regular communication is that no matter a signal is digital or analog, it is modulated and demodulated twice when transmitted and received according to the spread spectrum technique. The spread spectrum technique generally has two types of spread spectrum: direct sequence spread spectrum (DSSS) and frequency hopping spread spectrum (FHSS). Take FHSS for example to illustrate the operation of a spread spectrum system. Please refer to FIG. 1. FIG. 1 is a functional block diagram of a conventional spread spectrum system 10. The spread spectrum system 10 comprises a modulation end 12 and a demodulation end 22. The modulation end 12 comprises a first order modulator 14, a balance modulator (BM) 16, a first pseudo number (PN) generator 18, and a first antenna 20. The demodulation end 22 comprises a second order demodulator 24, a despreading demodulator 26, a second PN generator 28, a second antenna 30, a band pass filter (BPF) 32, and a comparator 34.

The operation of the modulation end 12 is described as below. The first order modulator 14 performs general analog communication (AC) modulation or digital communication (DC) modulation according to the nature of the input signals (analog or digital) at an input end of the modulation end 12. If input signals are analog, the first order modulator 14 adopts FM or PM modulation methods; otherwise, the first order modulator 14 adopts pulse-code modulation (PCM) or binary phase shift keying (BPSK). The BM 16 is used to perform the function of second order modulation at the modulation end 12, which greatly expands spectrums of input signals. When input signals are analog, the first PN generator 18 implements the function of second order modulation. When input signals are digital, the BM 16 adopts the modulation method of scramble number, which first generates a random digital number with modulated input signals and PN from the first PN generator 18 for a multiplication after input signals are modulated by the first order modulator 14 through PCM, then modulates by a carrier wave wherein the process of a multiplication is called spreading, and finally transmits modulated and spread input signals through the first antenna 20.

The operation of the demodulation end 22 is described below. The second antenna 30 receives modulated and spread radio signals from the first antenna 20. The despreading demodulator 26 receives a PN from the second PN generator 28 and radio signals received by the second antenna 30 for a multiplication, despreads the radio signals, and transmits the despread signals to the comparator 34 (its function is explained subsequently), which transmits the despread signals to the BPF 32. The BPF 32 filters the despread signals into intermediate-frequency signals. The second order demodulator 24 demodulates the intermediate-frequency signals into baseband signals and transmits the baseband signals to an output end of the demodulation end 22. Theoretically, the baseband signals are the same as the input signals inputted at the input end of the modulation end 12 at the beginning. During the despreading process, there must be synchronization between the second PN generator 28 and the first PN generator 18; in other words, a PN from the second PN generator 28 must agree with that from the first PN generator 18 so that the signals received by the despreading demodulator 26 are able to be despread to the original input signals for a multiplication with the same PN (through the BPF 32 and second order demodulator 24).

Please refer to FIG. 2A, 2B and 2C. FIG. 2A, 2B and 2C are spectrum variation diagrams of signals inputted to the spread spectrum system 10. FIG. 2A is a spectrum diagram of signals before input to the spread spectrum system 10. FIG. 2B is a spectrum diagram of spread spectrum signals modulated from the signals transmitted through the modulation end 12. FIG. 2C is a spectrum diagram of demodulated spread spectrum signals from spread spectrum signals received and demodulated by the demodulation end 22. From these diagrams, it can be seen that through spectrum spreading signals can be flattened, and the flattened signals can be returned to the original signals through despreading.

Generally speaking, spread spectrum signals are susceptible to noise when transmitted in the spread spectrum system 10. However, the spread spectrum system 10 solves this problem. Please refer to FIG. 3A to 3D. FIG. 3A to 3D illustrate how noise is reduced in the spread spectrum system 10. FIG. 3A is a spectrum diagram of signals desired to be transmitted. FIG. 3B is a spectrum diagram of spread spectrum signals in the spread spectrum system 10. FIG. 3C is a spectrum diagram of spread spectrum signals interfered with by noise. FIG. 3D is a spectrum diagram of despread signals. From FIG. 3A to FIG. 3D, after despreading, the intensity of noise is much less than that of the signals desired to be transmitted, thus the spread spectrum system 10 actually has the aforementioned characteristic of co-channel interference.

The method of DSSS utilizes more than ten spreading codes to spread “1” or “0” of basic signals into spread spectrum signals having ten or a hundred times bandwidth (in defense applications, the bandwidth of a basic signal may be increased a million times). A frequency having higher power and narrower bandwidth is transformed into a frequency having lower power (even lower than background noise) and wider bandwidth, so those persons intercepting the signals cannot easily determine whether it is an actual signal. A spread spectrum code with more bits is less susceptible to noise, while a spread spectrum code with fewer bits easily accommodates more users.

Basically, the number of bits in a spread spectrum used in DSSS is few; for example, the number of bits of a spread spectrum used in 2.4 GHz WLAN products is fewer than 20. DSSS in IEEE 802.11 uses 11-chip spread spectrum code (also known as Pseudo Noise Code, PN Code), Barker code being an example of such. The number of bits of a spread spectrum should be more than ten according to FCC regulations. According to experiments, the optimum number of bits for a spread spectrum is about one hundred, where the basic signal can be returned by handling the spread spectrum code twice. The so-called “handling” is actually operating the correlation between radio signals received by the second antenna 30 in the demodulation end 22 and PN from the second PN generator 28.

Please refer to FIG. 1 again. The despreading demodulator 26 in the spread spectrum system 10 is used to perform the abovementioned correlation operation (The component performing the correlation operation is called a matched filter.) The correlation operation is mainly used for signal acquisition. When a modulated spread radio signal is inputted into the despreading demodulator 26, the despreading demodulator 26 periodically (usually accordingly to a chip cycle) uses PN from the second PN generator 28 to perform the correlation operation for the modulated spread radio signal. If the identity of the signal is the same (matched) with the PN, the despreading demodulator 26 generates a pulse to show that the radio signal received by the demodulation end 22 is that generated by a modulation end 12, and not noise.

Please refer to FIG. 3D again. When the second antenna 30 in the demodulation end 22 receives spread spectrum signals, the circuit related to demodulating spread spectrum signals in the demodulation end 22 demodulates spread spectrum signals into the signals shown in the FIG. 3D. If the peak value of the signals in FIG. 3D is more than a predetermined value P, the demodulation end 22 recognizes that received signals are actual spread spectrum signals transmitted from the modulation end 12. If the peak value of the signals in FIG. 3D is less than the predetermined value P, the demodulation end 22 ignores these signals. The peak of the signals shown in FIG. 3D is higher than the predetermined value P because the demodulation end 22 receives spread spectrum signals directly transmitted from the modulation end 12.

However, with the advancement of spread spectrum techniques, electronic communication products using the technique as a communication means have become popular. Some of these products are used indoors, such as mobile phones and access points (APs). When receiving radio signals from a base station when indoors, mobile phones and APs receive radio signals not only directly transmitted from the base station but also generated by the base station and reflected from walls (also known as multipath). The demodulation end 22 in the conventional spread spectrum system 10 only receives the spread spectrum signals with the highest power level, which is more than the predetermined value, and ignores the spread spectrum signals transmitted via other paths to the demodulation end 22. As a result, the signal-to-noise ratio (SNR) of radio signals received by the demodulation end 22 in the conventional spread spectrum system 10 is usually not very high.

### SUMMARY OF INVENTION

It is therefore a primary objective of the present invention to provide a method for receiving radio signals with an access point utilizing spread spectrum technique to solve the abovementioned problem.

The access point of the present invention comprises a plurality of antennas and a processor. The method comprises the following steps: using the plurality of antennas to receive radio signals transmitted by the radio signal transmitter (e.g. a base station) and from other directions (multipath) during a predetermined period of time, and using the processor to sum up radio signals received by the plurality of antennas during the predetermined period of time to obtain a summation of radio signals transmitted directly from the radio signal transmitter to the access point and of radio signals transmitted via reflection from the radio signal transmitter to the access point.

The method is able to receive radio signals transmitted directly from the radio signal transmitter and via reflection from the radio signal transmitter, so the method can increase the SNR of radio signals received by the access point.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a conventional spread spectrum system.

FIG. 2A is a spectrum diagram of signals before input to the spread spectrum system of FIG. 1.

FIG. 2B is a spectrum diagram of spread spectrum signals modulated from the signals in FIG. 2A transmitted through the modulation end of FIG. 1.

FIG. 2C is a spectrum diagram of demodulated spread spectrum signals from the spread spectrum signals in FIG. 2B received and demodulated by the demodulation end of FIG. 1.

FIG. 3A is a spectrum diagram of signals to be transmitted via the conventional spread spectrum system of FIG. 1.

FIG. 3B is a spectrum diagram of spread spectrum signals in the spread spectrum system of FIG. 1.

FIG. 3C is a spectrum diagram of spread spectrum signals interfered with by noise.

FIG. 3D is a spectrum diagram of despread signals.

FIG. 4 is a functional block diagram according to the present invention method for receiving radio signals with an access point.

FIG. 5 is a flowchart of the present invention method for receiving radio signals with an access point.

FIG. 6 is a spectrum diagram of radio signals according to the present invention method for receiving radio signals with an access point.

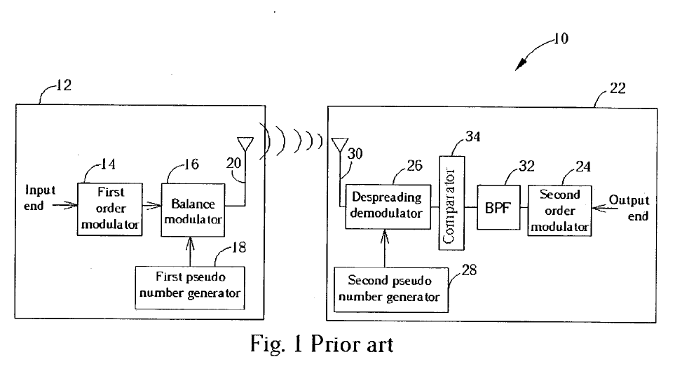

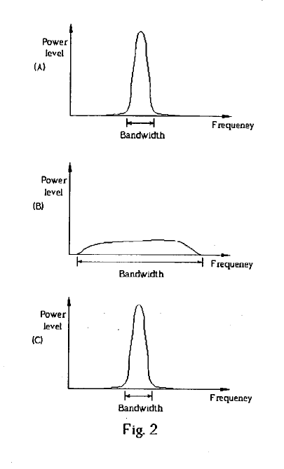

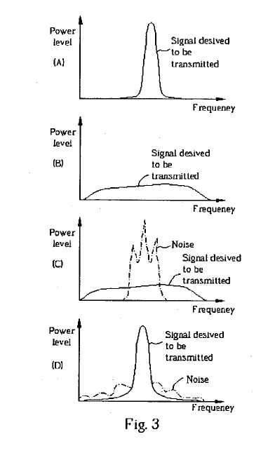

### DETAILED DESCRIPTION

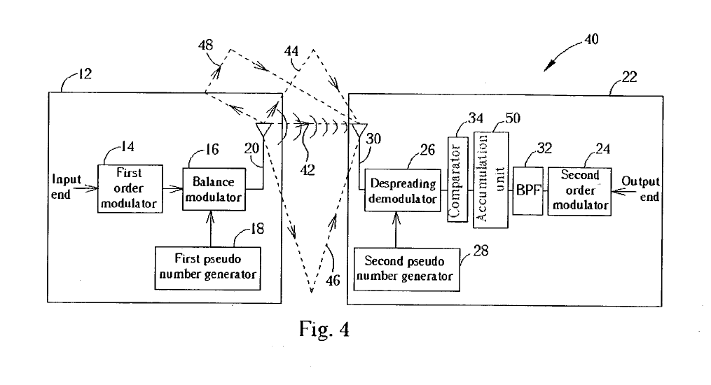

Please refer to FIG. 4. FIG. 4 is a functional block diagram according to the present invention method for receiving radio signals with an access point. A difference between a spread spectrum system 40 of the present invention and the conventional spread spectrum system 10 is that the demodulation end 22 in the spread spectrum system 40 (reference numbers of components of the spread spectrum system 40 identify components similar to those in the conventional spread spectrum system 10 having the same reference number) receives first radio signals 42 transmitted directly from the modulation end 12, second radio signals 44 and third radio signals 46 transmitted via single reflection from the modulation end, and fourth radio signals 48 transmitted via double reflection. Additionally, the demodulation end 22 in the spread spectrum system 40 further comprises an accumulation unit 50 used to accumulate the spread spectrum signals transmitted from the despreading demodulator 26 having power levels more than the predetermined value. The modulation end 12 in FIG. 4 applies to a radio signal transmitter (not shown), and the demodulation end 22 applies to an access point (not shown), which comprises a plurality of antenna to receive radio signals. Signals from the radio signal transmitter to the access point are transmitted on a 5.25 GHz or 2.4 Ghz carrier wave according to the IEEE 802.11a or the 802.11b specification.

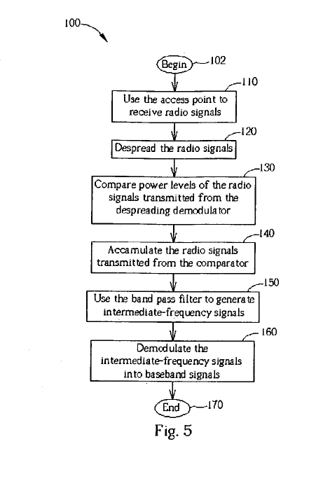

As mentioned above, the power level of the radio signals 42, 44, 46 and 48 received by the demodulation end 22 of the present invention is compared with that of the comparator 34. If the power level of a radio signal is more than a predetermined value, the accumulation unit 50 accumulates the radio signal; otherwise, the radio signal is ignored. Please refer to FIG. 5. FIG. 5 is a flowchart of the present invention method for receiving radio signals with an access point. The method comprises the following steps:

Step 100:

Begin. (The access point is indoors, while the radio signal transmitter can be indoors or outdoors and transmits modulated and spread spectrum radio signals.)

Step 110:

Use the plurality of antennas in the access point to receive the first radio signals 42 transmitted by the radio signal transmitter and the second, third and fourth radio signals 44, 46 and 48 transmitted from other directions during a predetermined period of time. (The period of time equals the period of the radio signal.)

Step 120:

Use the despreading demodulator 26 in the access point to despread the first radio signals 42 to the fourth radio signals 48. (PN from the second PN generator 28 and input signals from the despreading demodulator 26 are provided for a multiplication.)

Step 130:

Use the comparator 34 in the access point to compare the power level of output signals from the despreading demodulator 26. If the power level of an output signal is more than a predetermined value, the comparator 34 transmits the output signal to the accumulation unit 50. (The first radio signals 42 to the fourth radio signals 48 are combined to a radio signal during the period of time, so the comparator 34 comparing the power level of output signals from the despreading demodulator 26 means comparing the corresponding radio signals which are more than the predetermined value in a spectrum diagram of the combined radio signals.)

Step 140:

Use the accumulation unit 50 in the access point to accumulate the radio signals transmitted from the comparator 34.

Step 150:

Use the band pass filter 32 in the access point to generate intermediate-frequency signals.

Step 160:

Use the second order demodulator 24 in the access point to demodulate the intermediate-frequency signals into baseband signals.

Step 170: End.

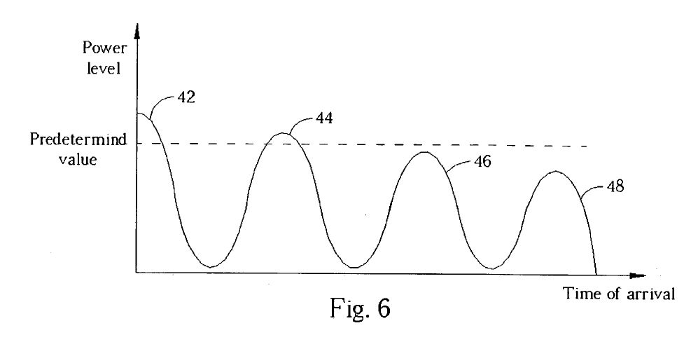

Consider the first radio signals 42 to the fourth radio signals 48 for example. Please refer to FIG. 6. FIG. 6 is a spectrum diagram of despreading radio signals combined from the first radio signals 42 to the fourth radio signals 48 received by the second antenna 30 in the access point. The ordinate is power level of the combined signal and the abscissa is time of arrival (TOA) of the combined signal. The first radio signals 42 to the fourth radio signals 48 are transmitted via different pathways so there are distinct phase differences between the four types of radio signals. As shown in FIG. 6, the first radio signals 42 arrived at the access point first, and the second radio signals 44, the third radio signals 46, and the fourth radio signals 48 arrive in turn. After despreading by the despreading demodulator 26, four peaks of the combined signal appear and correspond to these four types of radio signals 42, 44, 46 and 48. The peaks corresponding to the first radio signals 42 and the second radio signals 44 are more than the predetermined value, so only the first radio signals 42 and the second radio signals 44 are accumulated by the accumulation unit 50, the third radio signals 46 and the fourth radio signals 48 being ignored.

In contrast to the prior art, only receiving radio signals directly from the radio signal transmitter, the present invention receives not only radio signals transmitted directly from the radio signal transmitter but also radio signals transmitted via reflection from the radio signal transmitter having power levels higher than a predetermined value. Therefore, the present invention increases the SNR of radio signals received by the access point.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for receiving radio signals transmitted by a radio signal transmitter with an access point, the access point comprising a plurality of antennas and a processor, the method comprising:
using the plurality of antennas to receive radio signals transmitted from the radio signal transmitter and radio signals transmitted from other directions during a predetermined period of time; and
using the processor to sum up radio signals received by the plurality of antennas during the predetermined period of time to obtain a summation of radio signals transmitted directly from the radio signal transmitter to the access point and of radio signals transmitted via reflection from the radio signal transmitter to the access point.

2. The method of claim 1 wherein the radio signal transmitted from the radio signal transmitter to the plurality of antennas is on a carrier wave and the predetermined period of time equals a period of the carrier wave.

3. The method of claim 1 wherein the radio signal transmitted from the radio signal transmitter to the plurality of antennas is on a 2.4 Ghz carrier wave according to the IEEE 802.11b specification.

4. The method of claim 1 wherein the radio signal transmitted from the radio signal transmitter to the plurality of antennas is on a 5.25 Ghz carrier wave according to the IEEE 802.11a specification.
